(19) United States
(12) Patent Application Publication
(10) Pub. No.: US 2011/0240128 A1
(43) Pub. Date: Oct. 6, 2011

(54) METHOD AND APPARATUS FOR MONITORING OPERATION OF A PILOT-CONTROLLED PRESSURE RELIEF VALVE

(75) Inventors: Vincenzo Barbato, Stafford, TX (US); Bryan Brown, Rosenberg, TX (US)

(73) Assignee: TYCO VALVES & CONTROLS LP, Houston, TX (US)

(21) Appl. No.: 13/079,286

(22) Filed: Apr. 4, 2011

Related U.S. Application Data
(60) Provisional application No. 61/320,397, filed on Apr. 2, 2010.

(51) Int. Cl. F16K 51/00

(52) U.S. Cl. 137/1; 137/557

(57) ABSTRACT

A method for determining effective area coefficient for a pilot operated safety relief valve. The relief valve may have a piston with an upper surface area, an inlet, and a dome. The method may include determining a total force acting on the piston (Fₜₒₜₐₗ) and determining a downward force (F_{dome}) on the piston due to dome pressure. The method may further include determining an upward force on the piston due to inlet pressure (Fₘₐᵢₙ) by subtracting the downward force (F_{dome}) from the total force (Fₜₒₜₐₗ) and determining an instantaneous Effective Area coefficient (Aₑ) by dividing the upward force on the piston (Fₘₐᵢₙ) by a main inlet pressure (Pₘₐᵢₙ).

### BACKGROUND OF THE INVENTION

1. Field of the Invention

Embodiments of the invention generally relate to the field of testing pilot-controlled safety relief valves, and more particularly to the field of measuring instantaneous/dynamic effective area coefficient, and effective area vs. lift function, of pilot-controlled pressure relief valves.

2. Discussion of Related Art

In general, pilot controlled Safety Relief Valves (SRVs), have a main valve composed of a piston with a dome volume behind it, and a pilot valve for filling/dumping the dome volume. The main valve piston is exposed to pipe inlet pressure below and dome pressure above. The difference in exposed surface areas between the top and bottom of the piston keep the main valve closed, until the pilot valve dumps the gas in the dome volume, which lowers the dome pressure and causes the piston to lift.

As the main valve piston lifts and begins to relieve pressure from the protected system, the inlet pressure may only push against a portion of the exposed piston surface area as a result of gas flow and dynamic/parasitic effects. That portion coefficient is known as the “Effective Area” coefficient. In a steady flowing or slowly moving valve, this coefficient depends on piston lift. But in a rapidly moving valve, the Effective Area coefficient depends strongly on piston velocity, gas inertia, gas compliance and more. Since the analysis of valve instabilities involves rapidly moving SRVs, dynamic/parasitic effects such as piston inertia and gas inertia/compliance cannot be ignored.

One current method for measuring the Effective Area coefficient of pilot controlled SRVs is as follows: (1) raise the piping system, leading to the main valve inlet, up to an operating pressure; (2) keep the valve opened at different piston lift points, which is often done by holding the valve piston with a screw; (3) at each lift point, measure the lift force on the valve piston, which is often done with a load cell placed behind the valve piston; and (4) divide the lift force by the operating inlet pressure to obtain the coefficient.

There are variations of this method, but they all require steady-state or quasi-steady flow conditions. As a result, when dealing with unstable valves or rapidly moving valves, these methods fail because they do not consider valve dynamic/parasitic effects such as piston inertia, gas inertia, gas compliance and more, as previously noted.

Current methods do not take dynamic effects into account in the measurement/calculation of Effective Area coefficient. Certifications of valves require manufacturers to analyze valves in steady-state flowing conditions. The common belief is that valve stability/performance problems depend exclusively on fixed parameters such as pipe lengths and pipe turns/intersections. For the reasons previously noted, such techniques may result in inaccurate values of the Effective Area coefficient for an SRV.

Thus, there is a need for an improved method for measuring the instantaneous/dynamic Effective Area coefficient and “Effective Area vs. Lift” function of pilot-controlled SRV's.

### SUMMARY OF THE INVENTION

The disclosed method is an improved technique for measuring the instantaneous Effective Area coefficient and Effective Area vs. Lift function of rapidly moving pilot-controlled SRVs.

A method is disclosed for determining effective area coefficient for a pilot operated safety relief valve, the relief valve having a piston with an upper surface area, an inlet, and a dome. The method comprises the steps of: determining piston velocity (Pᵥₑₗ) and piston acceleration (P_{acc}); determining a total force acting on the piston (Ftotal) based on a mass of the piston and the piston acceleration; determining a downward force on the piston due to dome pressure (F_{dome}) by multiplying the dome pressure (P_{dome}) with the piston upper surface area (A_{UpperSurfaceArea}); determining an upward force on the piston due to inlet pressure (Fₘₐᵢₙ) by subtracting the downward force from the total force (Fₜₒₜₐₗ); determining a lift of the piston (P_{lift}); determining an instantaneous Effective Area coefficient (Aₑ) by dividing the upward force on the piston (Fₘₐᵢₙ) by a main inlet pressure (Pₘₐᵢₙ); and plotting the Effective Area coefficient vs. P_{lift} to determine the Effective Area coefficient (Aₑ) vs. piston (P_{lift}) function.

### BRIEF DESCRIPTION OF THE DRAWINGS

The accompanying drawing illustrates an exemplary embodiments of the disclosed device so far devised for the practical application of the principles thereof, and in which:

FIG. 1 is an exemplary safety relief valve;

FIG. 2 is an exemplary arrangement for performing the disclosed method;

FIG. 3 shows two plots of the Effective Area Coefficient vs. Lift of a valve run with different piston seat retainers;

FIG. 4 shows plots of Effective Area vs. Lift function for two different unstable runs on a valve with a flat nose retainer

### DESCRIPTION OF EMBODIMENTS

The disclosed method can be used to measure the instantaneous/dynamic “Effective Area Coefficient” and “Effective Area vs. Lift” function of pilot-controlled pressure relief valves. The disclosed arrangement can be used to obtain many other dynamic properties of valves, such as piston velocity and acceleration, kinetic and potential energy, frictional losses and much more. In one embodiment, the disclosed method calculates the instantaneous Effective Area coefficient of a pilot-controlled SRV using field sensor data.

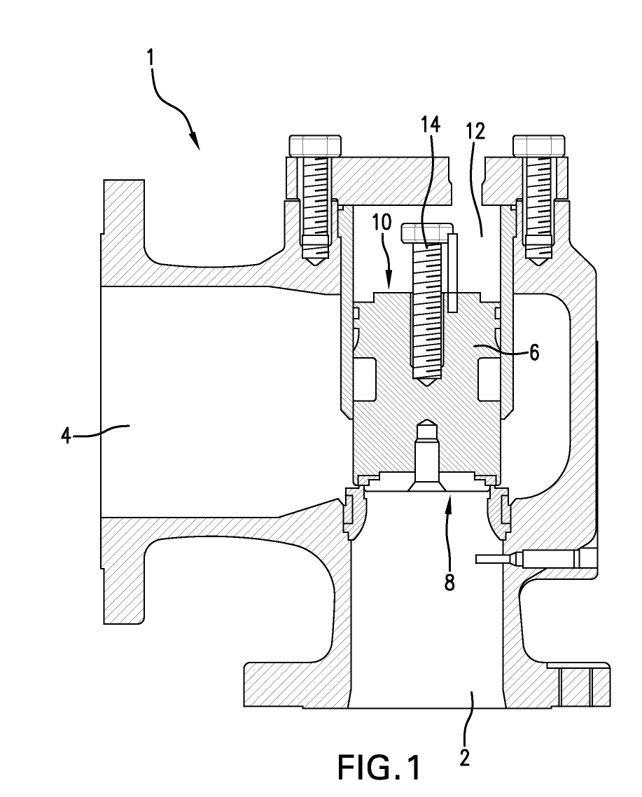

In general, pilot controlled SRVs (Safety Relief Valves), as shown in FIG. 1, have a main valve 1 comprising an inlet port 2, an outlet port 4, a piston 6 having a first piston face 8 exposed to main inlet pressure (i.e., the pressure of the system being protected), and a second piston face 10 exposed to dome pressure associated with a dome volume 12. The piston 6 is shown having a stop bolt 14 for limiting piston lift.

A pilot valve (not shown) is in communication with the dome volume 12 for filling/dumping the dome volume. As previously noted, the piston 6 is exposed to pipe inlet pressure below it (via the valve inlet port 2), and dome pressure above it. The difference in exposed surface areas between the faces 8, 10 of the piston 6 keep the valve 1 closed, until the pilot valve dumps the gas in the dome volume 12, lowering the dome pressure, and causing the piston 6 to move upward, opening a path between the inlet port 2 and the outlet port 4.

As the main valve piston lifts and starts relieving the protected system, gas flows around the piston. The gas applies a pressure-drag force that pushes the piston upwards. The inlet pressure, however, only acts against a portion of the exposed piston surface area. That portion is known as the “Effective Area” coefficient. Effective Area is the area which, when multiplied by the inlet pressure, equals to the upward pressure-drag force due to the gas flow. In a steady flowing or slowly moving valve, the Effective Area coefficient depends on piston lift. But in a rapidly moving valve, the Effective Area Coefficient depends strongly on piston velocity, gas inertia, gas compliance, frictional losses and more.

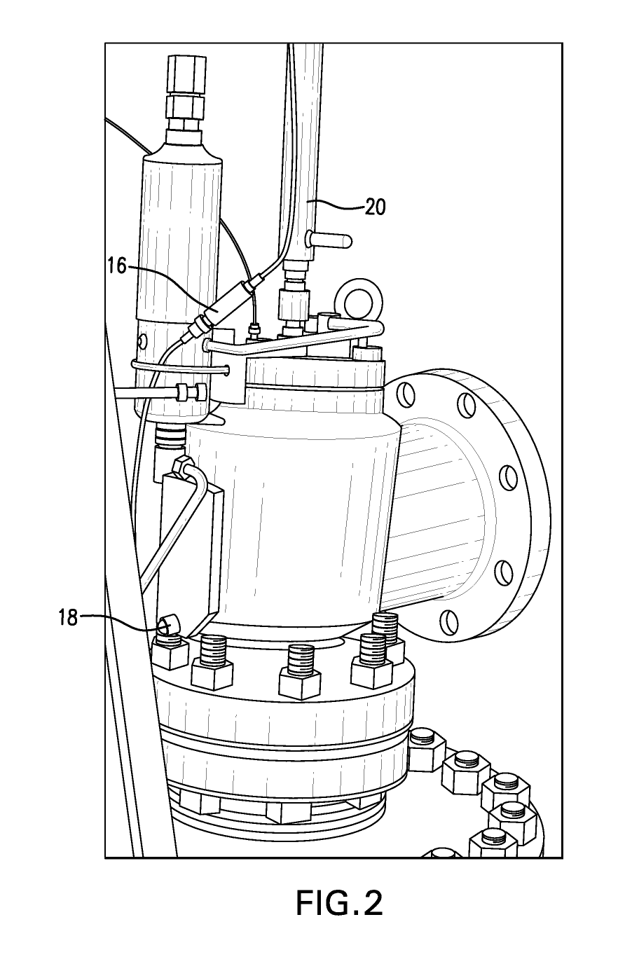

Referring to FIG. 2, the disclosed test arrangement includes a pressure sensor 16 positioned in the valve's dome 12 for measuring dome pressure, a pressure sensor 18 integral to the valve 1 to measure inlet pressure, and an inductive sensor such as a linear variable differential transformer (LVDT) lift sensor 20 to measure valve piston 6 lift. The setup as shown in FIG. 2, is simple and, as discussed, uses only three sensors. The illustrated arrangement uses an Anderson-Greenwood (A-G) 853 series P-orifice valve with an 800 series pilot modified to work at lower pressures.

The disclosed arrangement is unique in that it enables calculation of the dynamic Effective Area coefficient, as opposed to standard methods which are based on steady state flows. It also allows for on-line calculation of instantaneous Effective Area coefficient. This can, in turn, be used for on-line analysis of valve performance, valve stability and much more. The FIG. 2 arrangement enables real-time data to be obtained from the sensors 16, 18, 20, which provide a direct measure of dome pressure (P_{d}), inlet pressure (Pₘₐᵢₙ), and piston lift (P_{lift}). Using these values, and knowing the piston mass (Pₘₐₛₛ), the following analysis steps provide a real time determination/plot of the instantaneous Effective Area coefficient (Aₑ):

1. Calculate Piston Velocity (Pᵥₑₗ) and Piston Acceleration (P_{acc}) by differentiating the piston lift signal twice:

$$a . {P}_{vel} = \frac{d {P}_{lift}}{d t}$$

$$b . {P}_{acc} = \frac{d {P}_{vel}}{d t}$$

2. Calculate the total force acting on the valve's piston (Fₜₒₜₐₗ) by using Newton's second law:

Fₜₒₜₐₗ=Pₘₐₛₛ*P_{acc}

3. Calculate the downward force on the valve's piston due to dome pressure (F_{dome}) by multiplying the dome pressure (P_{dome}) with the piston upper surface area (A_{UpperSurfaceArea}):

F_{dome}=P_{dome}*A_{UpperSurfaceArea}

4. Calculate the upward force on the valve's piston due to inlet pressure (Fₘₐᵢₙ) by subtracting the dome force (F_{dome}) from the total force (Fₜₒₜₐₗ):

Fₘₐᵢₙ=Fₜₒₜₐₗ−F_{dome}

5. Calculate the instantaneous Effective Area coefficient (Aₑ) by dividing the upward force on the valve's piston (Fₘₐᵢₙ) by the main inlet pressure (Pₘₐᵢₙ):

$${A}_{e} = \frac{{F}_{main}}{{P}_{main}}$$

6. Calculate the Effective Area coefficient (Aₑ) vs. Lift (P_{lift}) function by plotting the Effective Area coefficient vs. piston lift:

Plot A_{edefi A}ₑ(P_{lift})

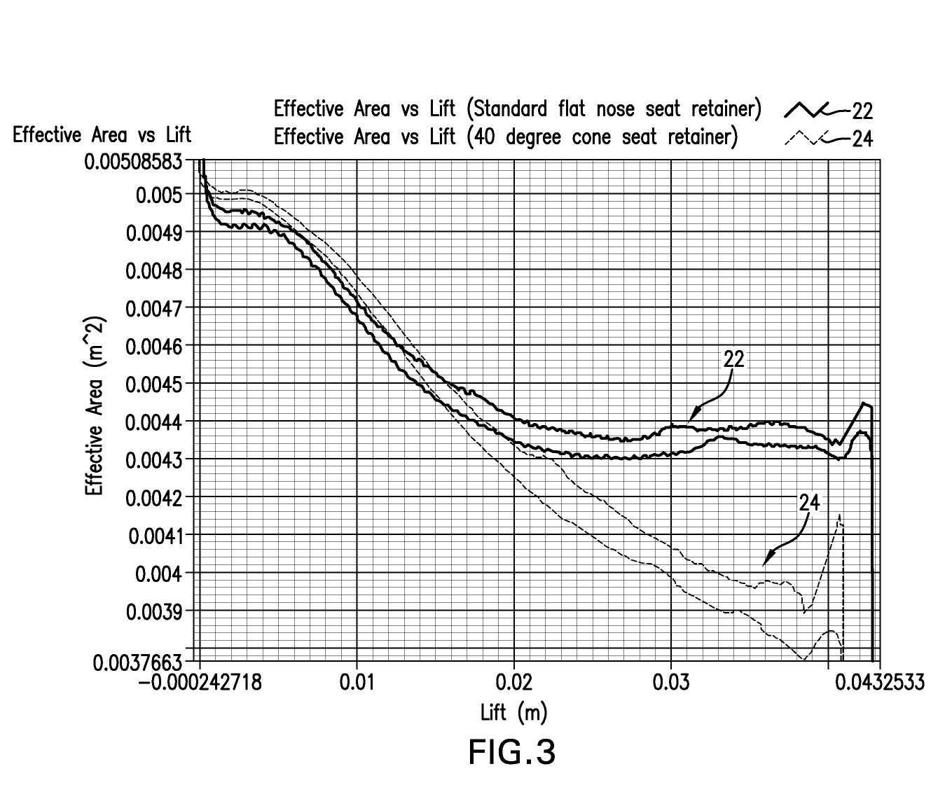

FIG. 3 shows plots generated using the disclosed method applied to a slowly moving valve, run with two different piston seat retainers. Specifically, FIG. 3 shows two plots of the Effective Area Coefficient (meters²) vs. Lift (meters) of a valve run with different piston seat retainers. This plot shows the real-time generated Aₑ(P_{lift}) curves 22, 24 for a quasi-steady valve with different piston seat retainers. Curve 22 is representative of a valve configuration using standard flat nose seat retainer, while curve 24 is representative of a valve configuration using 40-degree cone seat retainer. Even in this quasi-steady valve (an ideal case), the plot shows system hysteresis due to parasitic effects.

The ability of this method to generate real-time plots is advantageous when applied to rapidly opening/closing valves, as is the case for unstable valves. In such cases, parasitic effects can create highly non-linear interfaces between the piston and the flowing gas, which vary wildly from the smooth linear steady state condition.

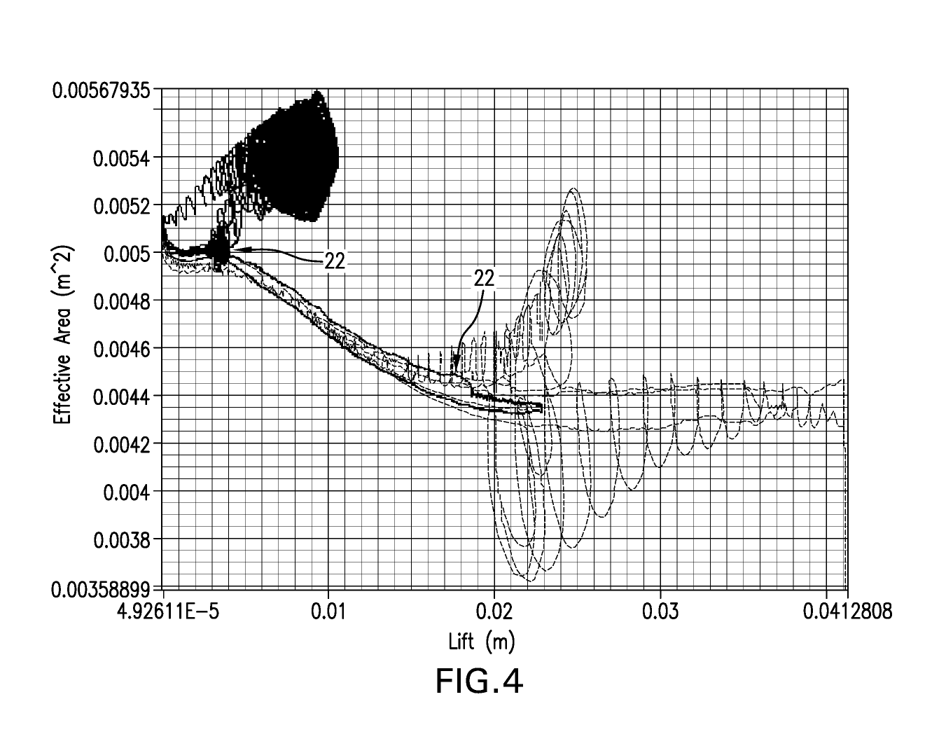

FIG. 4 shows a plot of the Effective Area vs. Lift function for two unstable runs on a valve using the test arrangement of FIG. 2. This plot shows the real-time generated Aₑ(P_{lift}) curve for a rapidly moving unstable valve with a flat nose retainer. In this case the non-linearity of the piston-gas interface are brought to the surface when the valve goes unstable. The plots show that when the valve becomes unstable, the effective area function varies non-linearly from its steady state form.

The method described herein may be automated by, for example, tangibly embodying a program of instructions upon a computer readable storage media capable of being read by machine capable of executing the instructions. A general purpose computer is one example of such a machine. A non-limiting exemplary list of appropriate storage media well known in the art would include such devices as a readable or writeable CD, flash memory chips (e.g., thumb drives), various magnetic storage media, and the like.

The features of the system and method have been disclosed, and further variations will be apparent to persons skilled in the art. All such variations are considered to be within the scope of the appended claims. Reference should be made to the appended claims, rather than the foregoing specification, as indicating the true scope of the disclosed method.

The functions and process steps disclosed herein may be performed automatically or wholly or partially in response to user command. An activity (including a step) performed automatically is performed in response to executable instruction or device operation without user direct initiation of the activity.

The systems and processes of FIGS. 1-4 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions and steps described herein may be implemented in hardware, software or a combination of both and may reside on one or more processing devices located at any location of a network linking the elements of the system or another linked network, including the Internet.

Thus, although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for determining an effective area coefficient for a pilot operated safety relief valve, the relief valve having a piston with an upper surface area, an inlet, and a dome, the method comprising:
determining a total force acting on the piston (Fₜₒₜₐₗ);
determining a downward force (F_{dome}) on the piston due to dome pressure;
determining an upward force on the piston due to inlet pressure (Fₘₐᵢₙ) by subtracting the downward force (F_{dome}) from the total force (Fₜₒₜₐₗ); and
determining an instantaneous effective area coefficient (Aₑ) by dividing the upward force on the piston (Fₘₐᵢₙ) by a main inlet pressure (Pₘₐᵢₙ).

2. The method of claim 1, the determining the total force comprising:
determining mass (Pₘₐₛₛ) of the piston;
determining acceleration (P_{acc}) of the piston; and
calculating the total force according to Fₜₒₜₐₗ=Pₘₐₛₛ*P_{acc}.

3. The method of claim 2, the determining P_{acc} comprising:
determining piston lift (P_{lift}) at a plurality of instances in time t;
differentiating P_{lift} as a function of time to determine piston velocity Pᵥₑₗ,
wherein dP_{lift}/dt=Pᵥₑₗₗ; and
differentiating Pᵥₑₗ as a function of time to determine P_{acc}, wherein
dPᵥₑₗ/dt=P_{acc}.

4. The method of claim 3, further comprising plotting Aₑ vs. P_{lift} for a plurality of piston lift positions to determine an effective area coefficient vs. piston lift function.

5. The method of claim 3, further comprising providing a lift sensor to measure P_{lift}.

6. The method of claim 5, the lift sensor comprising a linear variable differential transformer lift sensor.

7. The method of claim 1, the determining F_{dome} comprising:
measuring dome pressure (P_{dome});
determining an upper surface area (A_{UpperSurface}) of the piston; and
multiplying P_{dome} by A_{UpperSurface}.

8. The method of claim 1, comprising:
providing a dome pressure sensor to measure P_{dome}: and
providing an inlet pressure sensor configured to measure Pₘₐᵢₙ.

9. A relief valve monitoring system, the system arranged to monitor a pilot controlled safety relief valve that includes a piston having an upper surface area, an inlet disposed on a first side of the piston, and a dome disposed on a second side of the piston adjacent the upper surface area, the system comprising:
a dome pressure sensor configured to measure pressure of the dome;
an inlet pressure sensor for measuring inlet pressure; and
a lift sensor for measuring piston lift,
wherein the dome pressure sensor, inlet pressure sensor and lift sensor are interoperable to determine an instantaneous effective area coefficient (Aₑ) of the relief valve during movement of the piston.

10. The relief valve monitoring system of claim 9, wherein the system is configured to:
determine a total force acting on the piston (Fₜₒₜₐₗ);
determine a downward force (F_{dome}) on the piston due to the measured dome pressure;
determine an upward force on the piston due to inlet pressure (Fₘₐᵢₙ) by subtracting the downward force (F_{dome}) from the total force (Fₜₒₜₐₗ); and
determine the instantaneous effective area coefficient (Aₑ) by dividing the upward force on the piston (Fₘₐᵢₙ) by the measured inlet pressure (Pₘₐᵢₙ).

11. The relief valve monitoring system of claim 9, wherein the system is configured to:
determine acceleration (P_{acc}) of the piston using the lift sensor; and
calculate the total force according to Fₜₒₜₐₗ=Pₘₐₛₛ*P_{acc.}, where Pₘₐₛₛ is the mass of the piston.

12. The relief valve monitoring system of claim 9, wherein the system is configured to:
measure piston lift (P_{lift}) using the lift sensor while the piston is in motion at a plurality of instances in time t;
differentiate P_{lift} as a function of time to determine piston velocity Pᵥₑₗ,
wherein dP_{lift}/dt=Pᵥₑₗₗ; and
differentiate Pᵥₑₗ as a function of time to determine P_{acc}, wherein
dPᵥₑₗ/dt=P_{acc}.

13. The relief valve monitoring system of claim 9, wherein the system is configured to plot Aₑ vs. P₁ for a plurality of piston lift positions to determine an effective area coefficient vs. piston lift function.

14. The relief valve monitoring system of claim 9, the lift sensor comprising a linear variable differential transformer lift sensor.

15. The relief valve monitoring system of claim 9, wherein the system is configured to determine Aₑ vs P_{lift} when the piston is traveling in a first direction and in a second direction opposite the first direction.

16. The relief valve monitoring system of claim 15, wherein the system is configured to determine hysteresis in an Aₑ vs P_{lift} function between a first set of values of Aₑ obtained for a first set of P_{lift} positions when the piston is traveling in the first direction and a second set of values of Aₑ obtained for the first set of P_{lift} positions when the piston is traveling in the second direction.

17. The relief valve monitoring system of claim 15, wherein the system is configured to detect valve instability by determining a non-linearity in an Aₑ vs P_{lift} function.

18. A method for dynamically determining effective area coefficient for a pilot operated safety relief valve, comprising:
calculating, using lift position measurements of a piston of the relief valve, a total force acting on the piston (Fₜₒₜₐₗ) during operation of the piston;
measuring, during operation of the piston, a downward force (F_{dome}) on the piston due to dome pressure of a dome disposed on a first side of the piston;
measuring, during operation of the piston, a main inlet pressure (Pₘₐᵢₙ) of an inlet disposed on a second side of the piston, the second side being opposite the first side of the piston; and
determining an instantaneous effective area coefficient (Aₑ) by dividing an upward force on the piston due to main inlet pressure (Fₘₐᵢₙ) by the main inlet pressure Pₘₐᵢₙ, wherein Fₘₐᵢₙ=F_{dome}−Fₜₒₜₐₗ.

19. The method of claim 1, the calculating the total force comprising:
determining piston lift (P_{lift}) at a plurality of instances in time t;
doubly differentiating P_{lift} as a function of time to determine piston acceleration P_{acc}; and
calculating total force by Fₜₒₜₐₗ=Pₘₐₛₛ*P_{acc},
wherein Pₘₐₛₛ is mass of the piston.

20. The method of claim 19, further comprising plotting Aₑ vs. P₁ for a plurality of piston lift positions to determine an effective area coefficient vs. piston lift function.
